(19) United States
(12) Patent Application Publication
(10) Pub. No.: US 2022/0379620 A1
(43) Pub. Date: Dec. 1, 2022

(54) DISCHARGED LIQUID CONTAINER AND RECORDING APPARATUS

(71) Applicant: SEIKO EPSON CORPORATION, Tokyo (JP)

(72) Inventors: Satoshi NAKATA, Matsumoto-shi (JP); Katsumi YAMADA, Matsumoto-shi (JP)

(21) Appl. No.: 17/664,481

(22) Filed: May 23, 2022

(30) Foreign Application Priority Data
May 26, 2021 (JP) 2021-088213
May 26, 2021 (JP) 2021-088214

(51) Int. Cl. B41J 2/175; B41J 29/02

(52) U.S. Cl. CPC B41J 2/1752; B41J 29/02

(57) ABSTRACT

Provided is a discharged liquid container detachable to an apparatus having an outlet portion from which discharged liquid is to be drained, and configured to contain the discharged liquid drained from the outlet portion. The discharged liquid container includes a casing inside which the discharged liquid is containable, a connection portion provided in a first face of the casing and configured to be coupled to the outlet portion, and a lid portion configured to change in position between a closed state for covering the connection portion and an open state for opening the connection portion. The lid portion is configured to be in the open state in a state of attachment of the casing to the apparatus and be in the closed state in a state of detachment of the casing from the apparatus.

The present application is based on, and claims priority from JP Application Serial Number 2021-088214, filed May 26, 2021, and JP Application Serial Number 2021-088213, filed May 26, 2021, the disclosures of which are hereby incorporated by reference herein in their entirety.

### BACKGROUND

### 1. Technical Field

Embodiments of the present disclosure relate to a discharged liquid container and a recording apparatus.

### 2. Related Art

In related art, as disclosed in JP-A-2009-269206, a waste ink tank that is attachable to and detachable from a printer having an outlet portion for draining waste ink and is configured to, in an attached state, receive the waste ink drained from the outlet portion is known. The waste ink tank has a connection port (opening portion) to be coupled to the outlet portion. The waste ink tank further has a grip portion that is to be gripped by the user when the waste ink tank is attached or detached.

When the waste ink tank described briefly above is disconnected from the outlet portion by the user while the user grips the grip portion of the waste ink tank, in some cases, the waste ink tank is gripped with the opening portion facing downward. However, regardless of whether the waste ink tank has the grip portion or not, the dripping of the waste ink contained in the waste ink tank from the opening portion might occur due to gravity, which needs to be solved.

### SUMMARY

A certain aspect of the present disclosure is a discharged liquid container detachable to an apparatus and configured to contain discharged liquid, the apparatus having an outlet portion from which the discharged liquid is to be drained, the discharged liquid container being configured to contain the discharged liquid drained from the outlet portion, the discharged liquid container comprising: a casing inside which the discharged liquid is containable; a connection portion provided in a first face of the casing and configured to be coupled to the outlet portion; and a lid portion configured to change in position between a closed state for covering the connection portion and an open state for opening the connection portion; wherein the lid portion is configured to be in the open state in a state of attachment of the casing to the apparatus and be in the closed state in a state of detachment of the casing from the apparatus.

Another aspect of the present disclosure is a recording apparatus to which the above discharged liquid container is detachable, the recording apparatus comprising: a recording unit that performs recording by ejecting liquid onto a medium; wherein the discharged liquid container is configured to contain, as the discharged liquid, the liquid ejected onto a region outside an edge of the medium from the recording unit.

Still another aspect of the present disclosure is a recording apparatus to which the above discharged liquid container is detachable, the recording apparatus comprising: a recording unit that performs recording by ejecting liquid onto a medium; wherein the discharged liquid container is configured to contain the discharged liquid generated by performing maintenance for keeping the recording unit in a normal state.

### BRIEF DESCRIPTION OF THE DRAWINGS

FIG. 1 is a perspective view of the structure of a recording apparatus according to a first embodiment.

FIG. 2 is a perspective view of the structure of the recording apparatus according to the first embodiment.

FIG. 3 is a schematic view of the internal structure of the recording apparatus according to the first embodiment.

FIG. 4 is a plan view of the structure of a discharged liquid collection unit according to the first embodiment.

FIG. 5 is a perspective view of the structure of the discharged liquid collection unit according to the first embodiment.

FIG. 6 is a side view of the structure of the discharged liquid collection unit according to the first embodiment.

FIG. 7 is a perspective view of the structure of the recording apparatus according to the first embodiment.

FIG. 8 is a perspective view, with a discharged liquid container exposed, of the structure of the recording apparatus according to the first embodiment.

FIG. 9 is a perspective view of the structure of the discharged liquid container according to the first embodiment.

FIG. 10A is a schematic view of the structure of the discharged liquid container according to the first embodiment.

FIG. 10B is a schematic view of the structure of the discharged liquid container according to the first embodiment.

FIG. 10C is a schematic view of the structure of the discharged liquid container according to the first embodiment.

FIG. 11 is a side view of the structure of the discharged liquid container according to the first embodiment.

FIG. 12A is a schematic view of the structure of a discharged liquid container according to a second embodiment.

FIG. 12B is a schematic view of the structure of the discharged liquid container according to the second embodiment.

FIG. 13A is a schematic view of the structure of a discharged liquid container according to a third embodiment.

FIG. 13B is a schematic view of the structure of the discharged liquid container according to the third embodiment.

FIG. 13C is a schematic view of the structure of the discharged liquid container according to the third embodiment.

FIG. 14A is a perspective view of the structure of a discharged liquid container according to a fourth embodiment.

FIG. 14B is a plan view of the structure of the discharged liquid container according to the fourth embodiment.

FIG. 15 is an internal view of the structure, illustrating an absorber according to the fourth embodiment.

FIG. 16A is a perspective view of the structure of a discharged liquid container according to a fifth embodiment.

FIG. 16B is a perspective view of the structure of the discharged liquid container according to the fifth embodiment.

FIG. 17 is a cross-sectional view of the structure of a discharged liquid container according to a sixth embodiment.

FIG. 18A is an internal view of the structure of a discharged liquid container with an absorber according to a modification example.

FIG. 18B is an internal view of the structure of the discharged liquid container with the absorber according to the modification example.

FIG. 19 is a schematic view of the structure of a discharged liquid container with an absorber according to a modification example.

### DESCRIPTION OF EXEMPLARY EMBODIMENTS

### 1. First Embodiment

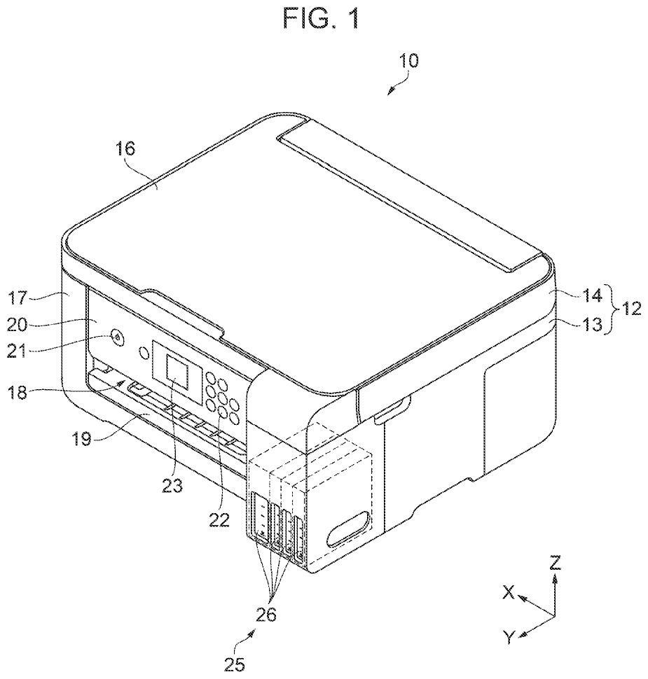

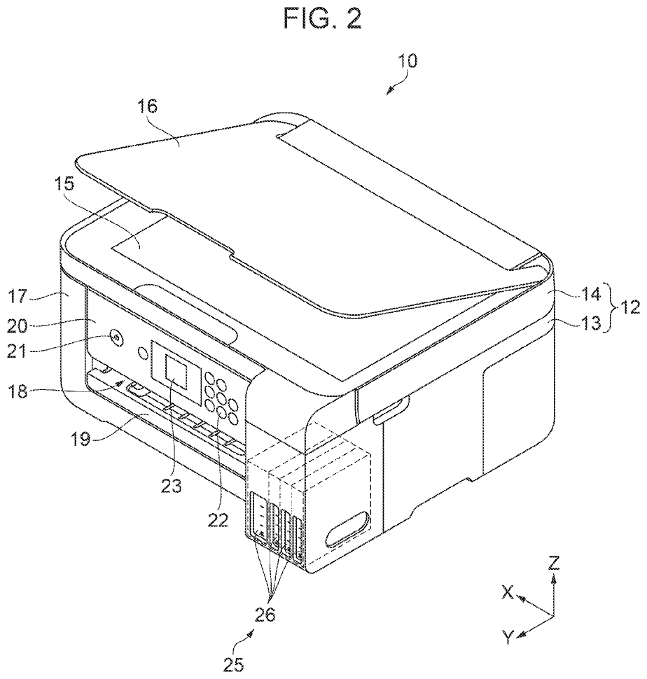

First, the structure of a recording apparatus 10 will now be explained. The recording apparatus 10 according to the present embodiment is a serial-type ink-jet printer that performs recording by ejecting ink as an example of liquid onto a medium P (for example, paper). Each of FIGS. 1 and 2 is a perspective view illustrating the structure of the recording apparatus 10. In a state in which the recording apparatus 10 is installed on an X-Y plane (horizontal plane) parallel to the X axis and the Y axis, the direction along the Z axis is a vertical direction, the +Z direction is a vertically upward direction, and the −Z direction is a vertically downward direction. The direction along the Y axis is a front-rear direction, the +Y direction is a forward direction (direction toward the front), and the −Y direction is a rearward direction (direction toward the rear). The direction along the X axis is a horizontal direction (width direction), the +X direction is a leftward direction, and the −X direction is a rightward direction.

As illustrated in FIGS. 1 and 2, an apparatus body 12 includes a cabinet 13, which has a shape like a rectangular parallelepiped, and a document reading device 14, which is disposed on the cabinet 13. The document reading device 14 has a document placement surface 15 and a document cover 16. The document placement surface 15 is a horizontal surface made of a transparent glass or the like on which a document to be read is to be placed. The document placement surface 15 can be covered by the document cover 16. The document cover 16 is provided in such a way as to be able to perform opening/closing operation by pivoting on a pivot shaft (not illustrated) extending in the width direction and parallel to the X axis, thereby switching between a closed state (FIG. 1) and an open state (FIG. 2). In the former state, the document cover 16 covers the document placement surface 15 from above. In the latter state, the document cover 16 opened from the former state exposes the document placement surface 15 to a space over it accessibly.

An ejection port 18 for ejecting the medium P from inside is provided at a lower position in a front face 17, which is the front of the apparatus body 12, among exterior faces of the cabinet 13. A stacker 19 for supporting, in a stacked state, sheets of the medium P each ejected frontward from the inside of the cabinet 13 is provided inside the ejection port 18.

An operation interface 20 configured to be operated by the user of the recording apparatus 10 is provided at an upper position on the front face 17 of the cabinet 13. The operation interface 20 is a rectangular panel having its longer sides in the width direction along the X axis. The operation interface 20 includes a power button 21 and operation buttons 22. The power button 21 is operated for turning the recording apparatus 10 ON/OFF. The operation buttons 22 are operated for inputting various kinds of operation information. In addition to these buttons, a liquid crystal display 23 capable of displaying operation status, etc. of the recording apparatus 10 is provided. The liquid crystal display 23 may be a touch panel.

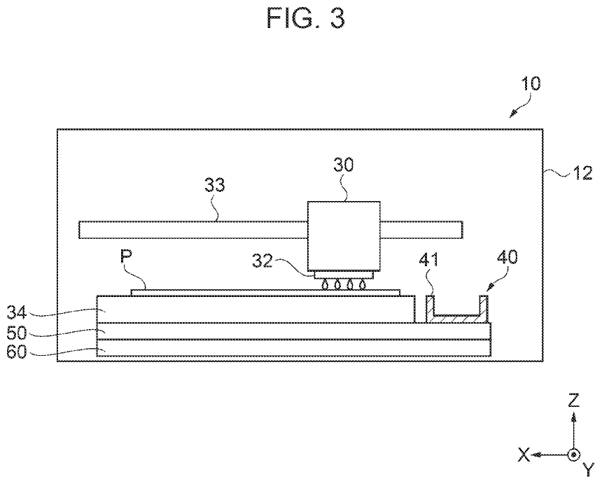

An ink-supplying unit 25 is provided behind the front face 17 of the cabinet 13. Ink is supplied from the ink-supplying unit 25 to a recording head 32 (FIG. 3). The ink-supplying unit 25 includes a plurality of ink tanks 26, etc. Each of the plurality of ink tanks 26 is a container that is able to contain ink.

Next, the internal structure of the recording apparatus 10 will now be explained. As illustrated in FIG. 3, the recording apparatus 10 includes a recording head 32, which is an example of a recording unit, and a carriage 30, on which the recording head 32 is mounted. The carriage 30 is supported on a guide rail 33 extending in the direction along the X axis. The carriage 30 is able to reciprocate in the direction along the X axis when driven by a driving mechanism that is not illustrated. A platen 34 for supporting the medium P that is transported is provided below the recording head 32. The recording head 32 has a plurality of nozzles. The recording head 32 ejects ink in the form of droplets onto the medium P supported by the platen 34. The platen 34 has a plate-like shape. The recording apparatus 10 includes a transportation mechanism that transports the medium P from a non-illustrated sheet feeding portion toward the ejection port 18 via the platen 34. The recording apparatus 10 executes recording operation, in which the recording head 32 ejects droplets to perform recording for one pass in the process of movement of the carriage 30 along the X axis, and transportation operation, by which the medium P is transported to the next recording position, alternately. By this alternate execution of recording operation and transportation operation, an image or a text, etc. is printed onto the medium P. In the present embodiment, an off-carriage-type configuration, in which the ink-supplying unit 25 including the ink tanks 26 is disposed at a position different from a position on the carriage 30, is adopted. However, an on-carriage-type configuration, in which the ink-supplying unit 25 including the ink tanks 26 is detachably mounted on the carriage 30, may be adopted. The recording apparatus 10 is not limited to a serial-type recording apparatus. For example, a line-type configuration, in which the recording head 32 is an elongated line head having its nozzles arranged throughout the entire maximum width of the medium P such that droplets can be ejected simultaneously throughout the entire maximum width of the medium P, may be adopted.

The recording apparatus 10 further includes a maintenance unit 40. The maintenance unit 40 performs maintenance so as to keep the recording head 32 in a normal state. For example, cleaning operation for discharging ink and air out of the recording head 32 forcibly is performed.

The maintenance unit 40 includes a cap 41. The carriage 30 is located at its home position, which is away from a recording area where recording operation is to be performed, while no recording operation is performed by the recording apparatus 10.

The cap 41 is a member disposed at the home position and having a shape like an open-topped box. The cap 41 is able to move in the direction along the Z axis when driven by an elevation mechanism. By being lifted, the cap 41 is pushed against the periphery of the bottom surface of the recording head 32. As a result, the cap 41 forms a closed space in such a way as to enclose the nozzles formed in the bottom surface of the recording head 32. The capping forming this closed space make it possible to prevent the drying of ink inside the nozzles of the recording head 32.

The cap 41 is connected to a suction pump through a suction tube. The suction pump operates with the space closed, thereby sucking ink and air present inside the recording head 32 through the suction tube. Due to this sucking operation, deteriorated ink (ink whose viscosity has increased due to drying) present inside the recording head 32 is sucked out. Therefore, the recording head 32 is kept in (or restored to) a normal state.

In the maintenance unit 40, in order to keep the recording head 32 in a normal state, flushing operation is performed periodically. The flushing operation is operation of discharging deteriorated ink present inside the recording head 32 by forcibly ejecting the ink out of the recording head 32 into the cap 41.

Ink discharged from the recording head 32 by performing maintenance such as cleaning operation or flushing operation (discharged liquid) is treated as waste liquid. Waste liquid is generated also when so-called borderless printing is performed. Specifically, when this kind of recording is performed by the recording head 32, ink ejected onto a region outside the edges of the medium P from the recording head 32 (discharged liquid) turns into waste liquid. Discharged liquid generated inside the apparatus body 12 as described above is collected by a discharged liquid collection unit 50. The discharged liquid collected by the discharged liquid collection unit 50 is drained to a discharged liquid container 60. The discharged liquid container 60 is configured to contain this drained discharged liquid.

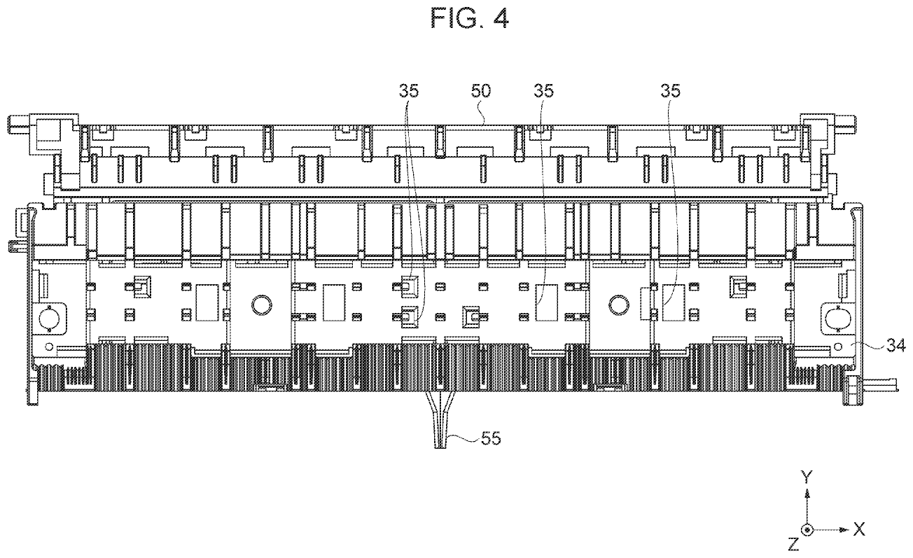

Next, the structure of the discharged liquid collection unit 50 will now be explained. As illustrated in FIG. 4, the discharged liquid collection unit 50 is disposed under the platen 34. The discharged liquid collection unit 50 has a plate-like shape. The discharged liquid collection unit 50 has a size that is large enough for supporting the entirety of the platen 34. A plurality of through holes 35 is provided in the platen 34. The through hole 35 is a hole going through the platen 34 in the vertical direction. Discharged liquid (Waste liquid) ejected wastefully onto the region outside the edges of the medium P in the process of borderless printing is drained to the discharged liquid collection unit 50, which is disposed under the platen 34, via the through holes 35.

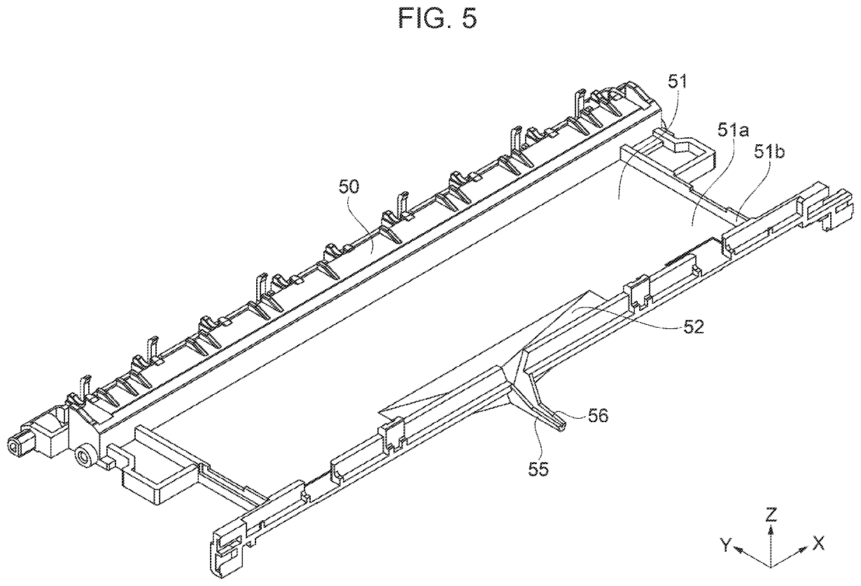

As illustrated in FIG. 5, the discharged liquid collection unit 50 has a receiving portion 51 for receiving the discharged liquid drained from the platen 34. The receiving portion 51 includes a flat portion 51a, which has a flat surface 51a, and a wall portion 51b, which encloses the flat portion 51a. The receiving portion 51 receives, at its flat portion 51a enclosed by its wall portion 51b, the discharged liquid drained from the platen 34.

The discharged liquid collection unit 50 has a recessed portion 52 that is recessed from the plane of the flat portion 51a downward. The recessed portion 52 is located at the center of the discharged liquid collection unit 50 in the direction along the X axis. This makes it possible to cause the discharged liquid in the flat portion 51a to flow into the recessed portion 52 easily. The discharged liquid collection unit 50 collects, as discharged liquid, waste liquid that is generated when borderless printing is performed. The waste liquid collected as discharged liquid is not limited thereto. Waste liquid discharged in the process of cleaning performed by the maintenance unit 40, or flushing, can be collected as discharged liquid via the cap 41.

The discharged liquid collection unit 50 has an outlet portion 55 from which the collected discharged liquid is drained to the discharged liquid container 60. The outlet portion 55 according to the present embodiment has a groove portion 56 which protrudes in the −Y direction and through which the discharged liquid flows. The groove portion 56 has an elongated spout cavity extending along the Y axis. The outlet portion 55 has an external shape whose size measured along the X axis decreases gradually in the −Y direction. In addition, the outlet portion 55 has an external shape whose size measured along the Z axis decreases gradually in the −Y direction. That is, the contour of the outlet portion 55 is tapered in the −Y direction. The outlet portion 55 protrudes from the bottom of the recessed portion 52 in the −Y direction. The groove portion 56 is sloped down in the −Y direction. This structure makes it possible for discharged liquid to flow from the recessed portion 52 toward the discharged liquid container 60 easily. Although the outlet portion 55 according to the present embodiment is located at the center of the discharged liquid collection unit 50 in the direction along the X axis, it may be located on the +X-directional side of the discharged liquid collection unit 50 or on the −X-directional side thereof.

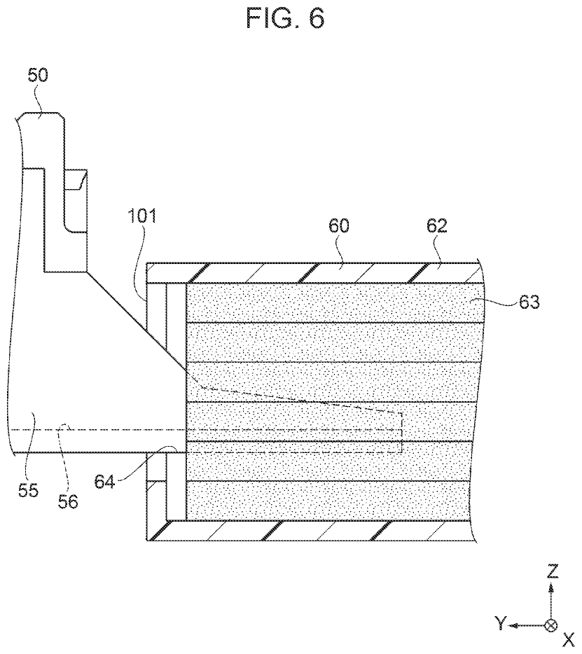

As illustrated in FIG. 6, the −Y-directional-side end part of the outlet portion 55 is inserted into the discharged liquid container 60 through a connection portion 64. Since the contour of the outlet portion 55 is tapered in the −Y direction, the insertion into the discharged liquid container 60 is easy. The insertion of the outlet portion 55 into the discharged liquid container 60 through the connection portion 64 ensures that discharged liquid will flow into the discharged liquid container 60 without a failure. The connection portion 64 is provided in a first face 101 of a casing 62. The first face 101 according to the present embodiment is the +Y-directional-side end face of the casing 62 in a state in which the discharged liquid container 60 is attached to the apparatus body 12. In the present embodiment, the inside of the casing 62 of the discharged liquid container 60 is stuffed with an absorber 63 configured to absorb discharged liquid. Therefore, the groove portion 56 of the outlet portion 55 comes into contact with the absorber 63 easily. Therefore, discharged liquid drained by flowing through the groove portion 56 of the outlet portion 55 is absorbed by the absorber 63.

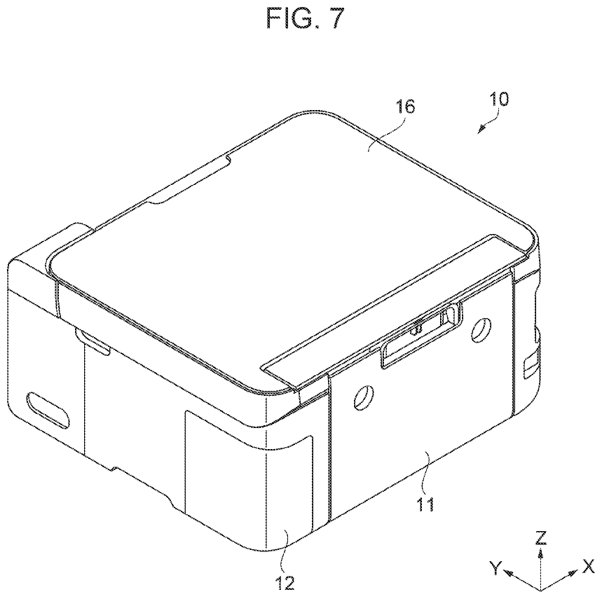

Next, the structure of the discharged liquid container 60 will now be explained. The discharged liquid container 60 is configured to receive, via the discharged liquid collection unit 50, discharged liquid generated inside the apparatus body 12, and is configured to contain the received discharged liquid. The discharged liquid container 60 can be detachably attached to the recording apparatus 10 (the apparatus body 12) as an example of an apparatus equipped with the outlet portion 55. There is a limit in the amount of discharged liquid that can be contained in the discharged liquid container 60. Because of the limited capacity, the discharged liquid container 60 needs to be replaced with new one timely. Therefore, when the amount of discharged liquid contained in the discharged liquid container 60 reaches a predetermined amount, the discharged liquid container 60 that is currently used is detached from the apparatus body 12, and a new discharged liquid container 60 is attached to the apparatus body 12. The amount of discharged liquid contained in the discharged liquid container 60 is determined based on, for example, the cumulative amount of ink ejected from the recording head 32. If the cumulative amount of ink ejected therefrom reaches a predetermined amount, a message, etc. indicating that the discharged liquid container 60 needs to be replaced is displayed on the liquid crystal display 23. Prompted by this display, the user removes, from the apparatus body 12, a rear cover 11, which is attached to the rear of the apparatus body 12 as illustrated in FIG. 7.

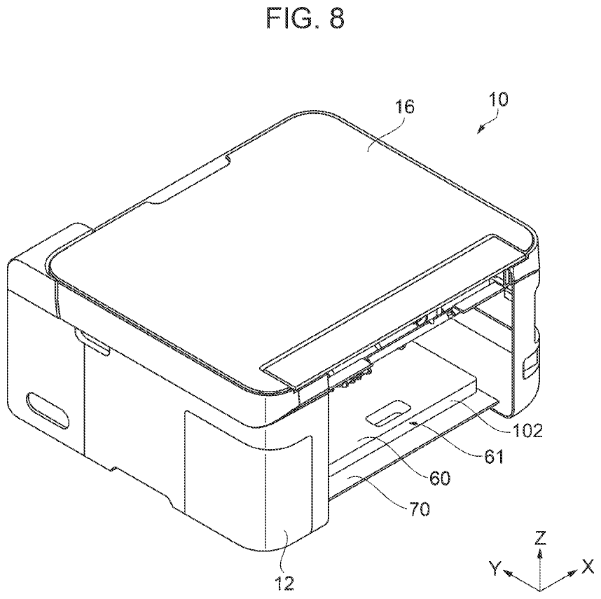

As a result, the discharged liquid container 60 becomes exposed as illustrated in FIG. 8. The discharged liquid container 60 is disposed in a state in which it is supported by a bottom plate portion 70. The discharged liquid container 60 has a grip portion 61 to be gripped with fingers. The grip portion 61 is provided on a second face 102. The second face 102 is the face that is the opposite of the first face 101, in which the connection portion 64 of the discharged liquid container 60 is provided. The user is able to detach the discharged liquid container 60 from the apparatus body 12 by drawing the discharged liquid container 60 in the −Y direction, with the user's fingers on the grip portion 61. To attach the discharged liquid container 60 to the apparatus body 12, the user inserts the discharged liquid container 60 into the apparatus body 12, with the connection portion 64 oriented in the +Y direction, and sets the discharged liquid container 60 on the bottom plate portion 70. After that, the user attaches the rear cover 11 to the rear of the apparatus body 12. Upon completion of replacement of the discharged liquid container 60 with new one, the cumulative count of ink ejected from the recording head 32 is reset.

The discharged liquid container 60 is attachable to and detachable from the apparatus body 12. When the discharged liquid container 60 is detached from the outlet portion 55 with the grip portion 61 thereof gripped as described above, there is a possibility of gripping, with the grip portion 61 oriented upward. If gripped in this way, the connection portion 64 is oriented downward; therefore, there is a risk that discharged liquid contained in the discharged liquid container 60 might drip from the connection portion 64 due to gravity. If discharged liquid drips from the connection portion 64, various problems such as staining the hand/body of the user, or the user's property, etc. with the drips might occur. In order to avoid these problems, the discharged liquid container 60 according to the present embodiment has a structure for preventing discharged liquid from dripping from the connection portion 64 no matter which orientation the discharged liquid container 60 is gripped in, in addition to a case where the connection portion 64 is oriented downward, in a state of having been detached from the apparatus body 12. The structure of the discharged liquid container 60 will now be explained in detail.

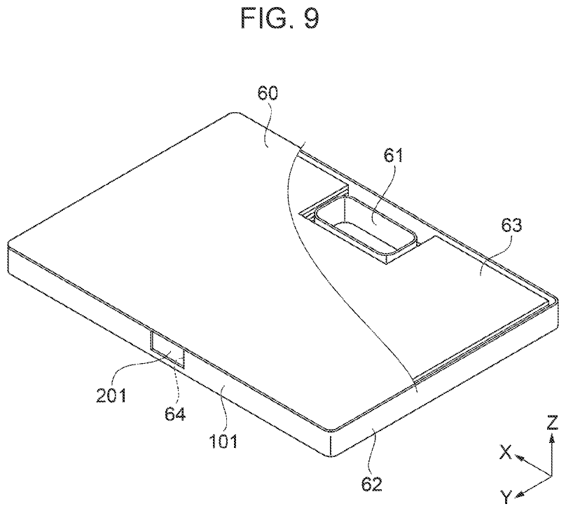

As illustrated in FIG. 9, the discharged liquid container 60 includes the casing 62, which is made of a resin material. The casing 62 is a container that is able to contain discharged liquid drained thereto. The connection portion 64 for connection to the outlet portion 55 is provided on a part of the casing 62 of the discharged liquid container 60. The connection portion 64 is provided in the first face 101, which is the +Y-directional-side end face of the casing 62. The connection portion 64 according to the present embodiment has an opening (through hole). The discharged liquid collected by the discharged liquid collection unit 50 flows into the casing 62 through the connection portion 64. A lid portion 201 is provided on the connection portion 64. The connection portion 64 according to the present embodiment is located at the center of the first face 101 in the direction along the X axis. However, the connection portion 64 does not necessarily have to be located at the center of the first face 101 in the direction along the X axis.

In the present embodiment, the absorber 63 is provided inside the casing 62. The absorber 63 is a member having a function of absorbing discharged liquid. The absorber 63 is, for example, a nonwoven fabric or a sponge. Every part of the inside of the casing 62 is stuffed with the absorber 63. Therefore, in the present embodiment, the discharged liquid collected by the discharged liquid collection unit 50 flows into the casing 62 through the connection portion 64 and is then absorbed by the absorber 63 and thus retained therein. Since the discharged liquid is retained, it is possible to prevent the dripping of the discharged liquid more effectively.

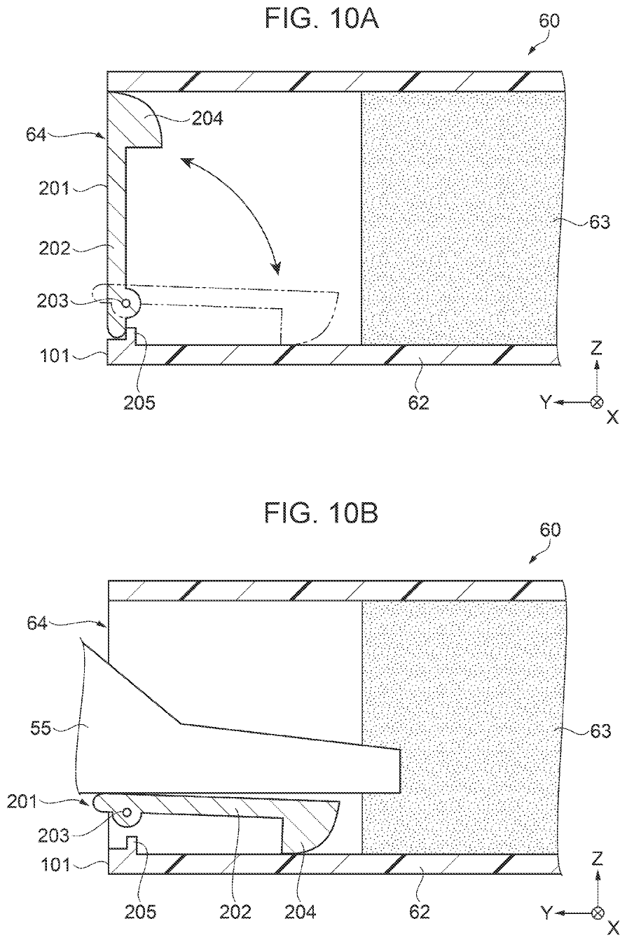

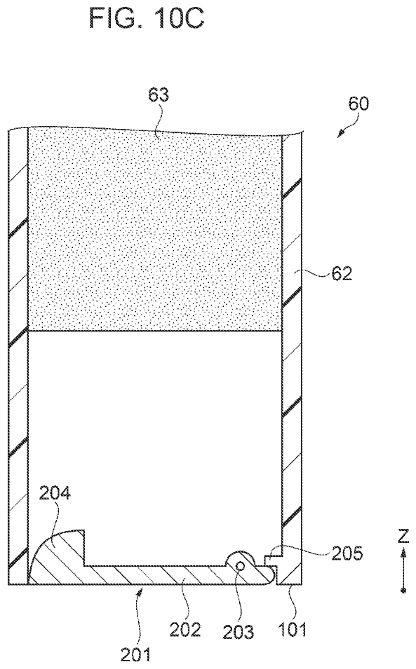

As illustrated in FIG. 10A, the discharged liquid container 60 includes the lid portion 201, which is able to change in position between a closed state and an open state. When closed, the lid portion 201 covers the connection portion 64. When opened, the lid portion 201 opens the connection portion 64. The lid portion 201 is able to be in an open state (FIG. 10B) in a state of attachment of the casing 62 to the apparatus body 12 and be in a closed state (FIG. 10C) in a state of detachment of the casing 62 from the apparatus body 12.

The lid portion 201 according to the present embodiment is provided rotatably on the connection portion 64. Specifically, the lid portion 201 includes an opening/closing member 202, which has a shape like a plate, and a shaft 203, around which the opening/closing member 202 is able to rotate. The opening/closing member 202 has approximately the same size as the size of the opening of the connection portion 64. The shaft 203 is disposed in the −Z-directional-side end portion of the opening/closing member 202 and extends in the direction along the X axis. The opening/closing member 202 is able to move around the shaft 203 in an opening direction and a closing direction. Therefore, just with a simple structure, the lid portion 201 is able to change in position between an open state and a closed state.

When the discharged liquid container 60, with the lid portion 201 closed, is attached to the apparatus body 12, in the process of the attachment, the outlet portion 55 pushes the opening/closing member 202 of the lid portion 201 in the −Y direction as illustrated in FIG. 10B. As a result, the opening/closing member 202 rotates around the shaft 203, and the lid portion 201 becomes open.

As illustrated in FIG. 10C, when the discharged liquid container 60 is detached from the apparatus body 12 and when the first face 101 is directed downward, the lid portion 201 is in a closed state. A weight portion 204 is provided at the other end that is the opposite of the end portion where the shaft 203 of the opening/closing member 202 is provided. The weight portion 204 is a part that is thicker than the other parts of the opening/closing member 202. The presence of the weight portion 204 gives an impetus to rotation around the shaft 203, thereby enabling the lid portion 201 to be in a closed state smoothly. That is, in the present embodiment, the lid portion 201 is in a closed state from an open state due to its own weight. This makes it unnecessary to provide any special structure for causing the lid portion 201 to change in position, resulting in a simpler structure. In the process of putting the lid portion 201 into a closed state from an open state, the −Z-directional-side end of the opening/closing member 202 comes into contact with a convex portion 205 provided on an inner wall of the casing 62 so as not to allow further rotational movement of the opening/closing member 202. Due to this stopping, the closed lid is kept in position.

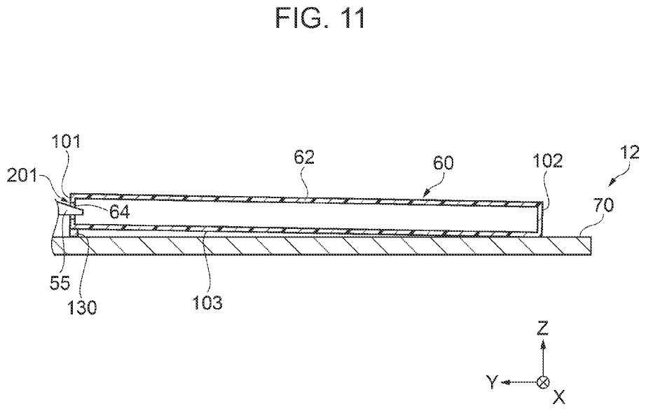

As illustrated in FIG. 11, the casing 62 has a third face 103 intersecting with the first face 101. When the discharged liquid container 60 is placed on the apparatus body 12 with the third face 103 facing down, the inside of the third face 103 is sloped down toward a direction going away from the position of junction of the first face 101 and the third face 103 (in the −Y direction). Because of this inclination, the side where the connection portion 64 is provided is located above the other portion. Therefore, when the discharged liquid container 60 is placed, the connection portion 64 is not oriented downward. For this reason, it is possible to prevent discharged liquid from flowing toward the connection portion 64.

In the present embodiment, the third face 103 is a flat surface, and a projection 130 is provided on the third face 103 at a position closer to the first face 101 than the center is. More specifically, the projection 130 having a downward convex shape is provided on the +Y-directional-side end of the third face 103. When the discharged liquid container 60 is attached to the apparatus body 12, the head face of the projection 130 is brought into contact with the bottom plate portion 70. Since the discharged liquid container 60 is placed with a slope going down in the −Y direction due to the presence of the projection 130, it is possible to prevent discharged liquid from flowing toward the connection portion 64. The discharged liquid container 60 may be placed on a desk or a floor, with the projection 130 of the discharged liquid container 60 oriented downward. Even if the discharged liquid container 60 is placed in this way, the casing 62 is sloped down from the first face 101 toward the second face 102 and, therefore, it is possible to prevent discharged liquid from flowing toward the connection portion 64.

As described above, since the connection portion 64 is equipped with the lid portion 201, the present embodiment makes it possible to prevent discharged liquid from dripping from the connection portion 64. In addition, since the lid portion 201 is configured to be in a closed state when the connection portion 64, from which discharged liquid might drip otherwise, is in downward orientation, it is possible to prevent the discharged liquid from dripping therefrom. The meaning of the term “downward” as used herein is not limited to the case of being oriented vertically downward; it encompasses cases where a downward component is included. The meaning of the term “closed state” as used herein is not limited to the state of perfect closing of the connection portion 64. It is sufficient as long as at least a part of the connection portion 64 is closed. In the present embodiment, a torsion spring may be provided on the shaft 203, and the opening/closing member 202 may be urged by the torsion spring toward its closing position. In this structure, when the outlet portion 55 gets connected to the connection portion 64, the outlet portion 55 causes the lid portion 201 to move against an urging force applied by the torsion spring and thus change from a closed state to an open state. When the outlet portion 55 gets disconnected from the connection portion 64, the lid portion 201 changes from an open state to a closed state with the help of an urging force applied by the torsion spring. Even when such a torsion spring is additionally provided, it is possible to cause the lid portion 201 to change in position, just with a simple structure.

### 2. Second Embodiment

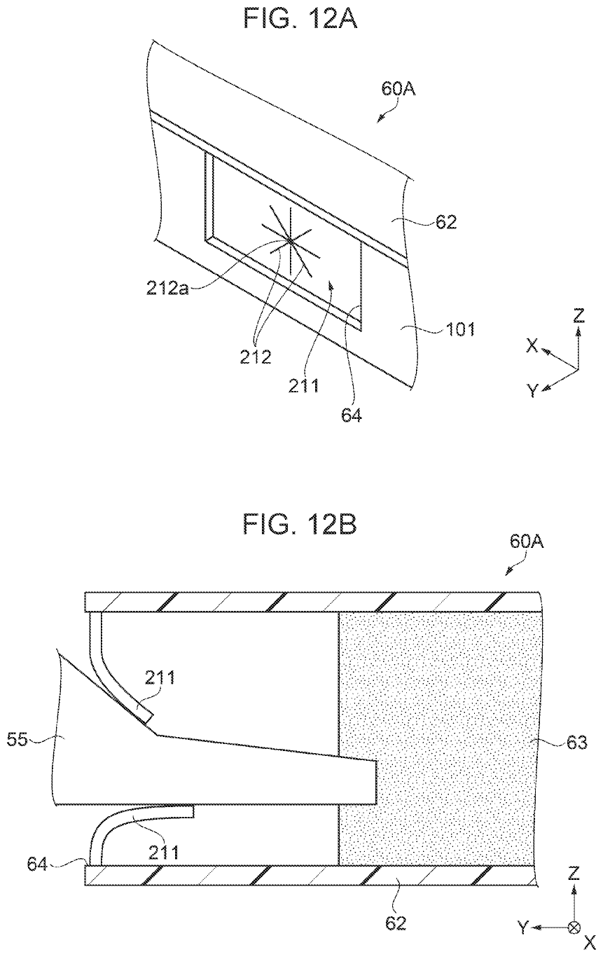

Next, a second embodiment will now be explained. The same reference numerals are assigned to components that are the same as those of the first embodiment. An explanation of them is omitted. In the present embodiment, the structure of a discharged liquid container 60A, which includes a lid portion 211 provided on the connection portion 64, will be explained. As illustrated in FIGS. 12A and 12B, the discharged liquid container 60A includes the lid portion 211, which is able to change in position between a closed state and an open state. When closed, the lid portion 211 covers the connection portion 64. When opened, the lid portion 211 opens the connection portion 64. The lid portion 211 is open in a state in which the casing 62 is attached to the apparatus body 12. The lid portion 211 is able to be in a closed state at the point in time of detachment of the casing 62 from the apparatus body.

The lid portion 211 is an elastic member configured to cover the connection portion 64. The elastic member has slits 212. The slit 212 is a cut extending from the center point 212a of the lid portion 211 toward the periphery of the lid portion 211. A plurality of slits 212 is formed such that each of them goes through the center point 212a.

Since the lid portion 211 is an elastic member, the lid portion 211 is self-urged toward its closing position. When the discharged liquid container 60, with the lid portion 211 closed, is attached to the apparatus body 12, in the process of the attachment (in the process of the coupling of the outlet portion 55 to the connection portion 64), the outlet portion 55 pushes the lid portion 211 in the −Y direction against a self-urging force acting on the lid portion 211. Because of this pushing, the lid portion 211 becomes deformed and changes from a closed state to an open state. This makes it unnecessary to provide any special structure for controlling the opening and closing of the lid portion 211, resulting in a simpler structure.

The lid portion 211 is in a closed state at the point in time of detachment of the discharged liquid container 60A from the apparatus body 12. That is, due to its own elastic resilience, the lid portion 211 changes from an open state to a closed state in accordance with the movement of the outlet portion 55.

As described above, in the present embodiment, the lid portion 211 always becomes closed when the discharged liquid container 60A is detached from the apparatus body 12; therefore, it is possible to prevent discharged liquid from dripping from the connection portion 64. The lid portion 211 according to the present embodiment may be used in combination with the lid portion 201 according to the first embodiment, which is a rotational-type lid portion. Specifically, the lid portion 211 may be disposed additionally outside the rotary lid portion 201. This structure makes it possible to prevent the dripping of discharged liquid more effectively.

### 3. Third Embodiment

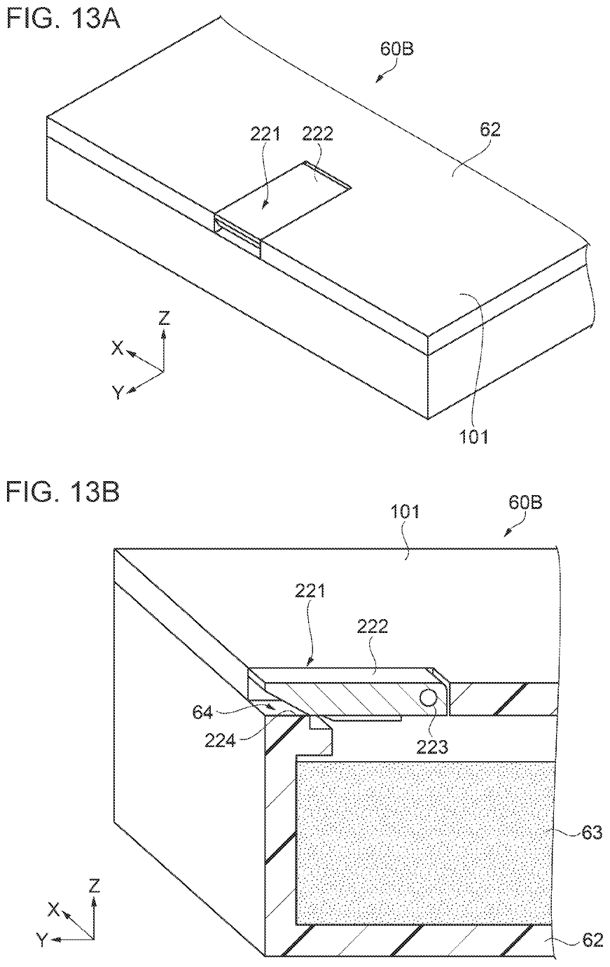

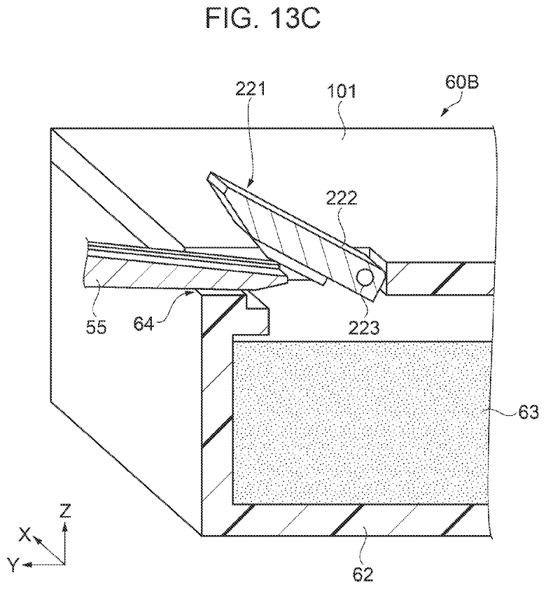

Next, a third embodiment will now be explained. The same reference numerals are assigned to components that are the same as those of the first embodiment. An explanation of them is omitted. In the present embodiment, the structure of a discharged liquid container 60B, which includes a lid portion 221 provided on the connection portion 64, will be explained. As illustrated in FIGS. 13A and 13B, the discharged liquid container 60B includes the lid portion 221, which is able to change in position between a closed state and an open state. When closed, the lid portion 221 covers the connection portion 64. When opened, the lid portion 221 opens the connection portion 64. The lid portion 221 is able to be in an open state (FIG. 13C) in a state of attachment of the casing 62 to the apparatus body 12 and be in a closed state in a state of detachment of the casing 62 from the apparatus body 12.

The first face 101 of the discharged liquid container 60B according to the present embodiment is the upper surface of the casing 62. That is, the connection portion 64 is disposed in the first face 101, which is the upper surface.

The lid portion 221 according to the present embodiment is provided rotatably on the connection portion 64. Specifically, the lid portion 221 includes an opening/closing member 222, which has a shape like a plate, and a shaft 223, around which the opening/closing member 222 is able to rotate. The opening/closing member 222 has approximately the same size as the size of the opening of the connection portion 64. The shaft 223 is disposed in the −Y-directional-side end portion of the opening/closing member 222 and extends in the direction along the X axis. The opening/closing member 222 is able to move around the shaft 223 in an opening direction and a closing direction. Therefore, just with a simple structure, the lid portion 221 is able to change in position between an open state and a closed state.

When the discharged liquid container 60B, with the lid portion 221 closed, is attached to the apparatus body 12, in the process of the attachment, the head end portion of the outlet portion 55 comes into contact with the +Y-directional-side lower end portion of the opening/closing member 222 as illustrated in FIG. 13C. As a result, the +Y-directional-side end portion of the opening/closing member 222 moves upward around the shaft 223, and the lid portion 221 is in an open state. In other words, when the outlet portion 55 gets connected to the connection portion 64, the outlet portion 55 causes the lid portion 221 to move against its own weight and thus change from a closed state to an open state. This makes it possible to perform opening/closing operation of the lid portion 221, just with a simple structure.

The lid portion 221 is in a closed state when the discharged liquid container 60B is detached from the apparatus body 12 as illustrated in FIGS. 13A and 13B. Specifically, the closed state of the opening/closing member 222 is kept by the contact of the +Y-directional-side lower end portion of the opening/closing member 222 with a contact portion 224, which is disposed under the +Y-directional-side lower end portion of the opening/closing member 222. That is, in the present embodiment, the lid portion 221 is in a closed state from an open state due to its own weight. This makes it unnecessary to provide any special structure for causing the lid portion 221 to change in position, resulting in a simpler structure.

As described above, in the present embodiment, since the connection portion 64 is provided in the upper surface of the discharged liquid container 60B, it is less likely that the user will direct the connection portion 64 downward when the discharged liquid container 60B is detached; therefore, it is possible to prevent discharged liquid from dripping from the connection portion 64.

In the present embodiment, a torsion spring may be provided on the shaft 223, and the opening/closing member 222 may be urged by the torsion spring toward the contact portion 224. In this structure, when the outlet portion 55 gets connected to the connection portion 64, the outlet portion 55 causes the lid portion 221 to move against an urging force applied by the torsion spring and thus change from a closed state to an open state. When the outlet portion 55 gets disconnected from the connection portion 64, the lid portion 221 changes from an open state to a closed state with the help of an urging force applied by the torsion spring. Even when such a torsion spring is additionally provided, it is possible to cause the lid portion 221 to change in position, just with a simple structure.

### 4. Fourth Embodiment

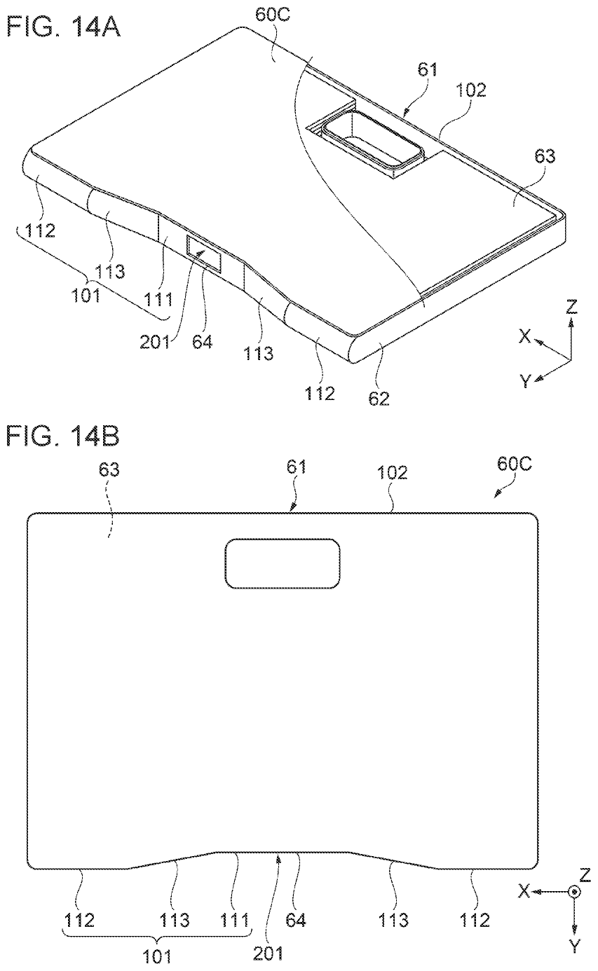

Next, a fourth embodiment will now be explained. The same reference numerals are assigned to components that are the same as those of the first embodiment. An explanation of them is omitted. In a discharged liquid container 60C according to the present embodiment, the shape of the first face 101 of the casing 62 is different from that of the foregoing embodiment. Specifically, as illustrated in FIGS. 14A and 14B, the first face 101 of the casing 62 according to the present embodiment includes a first portion 111, in which the connection portion 64 and the lid portion 201 are provided, and a second portion 112, which is located on a nearer side in comparison with the first portion 111 in a plan view from the side where the first face 101 is located. That is, the first portion 111 is located at a concave portion recessed from the second portion 112, and the second portion 112 is bulged from the first portion 111. In the present embodiment, the second portion 112 is provided on the +X-directional side with respect to the connection portion 64 and on the −X-directional side with respect to the connection portion 64. Because of this structure, even if the discharged liquid container 60C is gripped with the connection portion 64 oriented downward, discharged liquid contained in the casing 62 flows toward the second portion 112, which is located at a lower position in comparison with the connection portion 64; therefore, it is possible to prevent the discharged liquid from dripping from the connection portion 64.

The first face 101 further includes a third portion 113, which is a slope for connection between the first portion 111 and the second portion 112. Specifically, the third portion 113 has a sloped surface sloping down from the first portion 111 to the second portion 112 when the second face 102 of the casing 62 is directed upward and the first face 101 thereof is directed downward. Because of this structure, it is possible to cause discharged liquid to flow smoothly from the first portion 111 toward the second portion 112. The third portion 113 may have a shape for connection between the first portion 111 and the second portion 112 at a right angle.

The discharged liquid container 60C has a shape that makes it difficult for the discharged liquid container 60C to be placed in an upright position on, for example, a desk or a floor, with the connection portion 64 facing down. Specifically, the second portion 112 has a rounded shape. In the present embodiment, the second portion 112 has a curved surface that is a convex in the +Y direction when the discharged liquid container 60C is viewed in the +X direction. Because of this structure, the discharged liquid container 60C cannot be placed with the first face 101 facing downward. Since the discharged liquid container 60C cannot be placed with the connection portion 64 oriented downward, the connection portion 64 will never be in downward orientation in a placed state; therefore, it is possible to prevent discharged liquid from dripping from the connection portion 64.

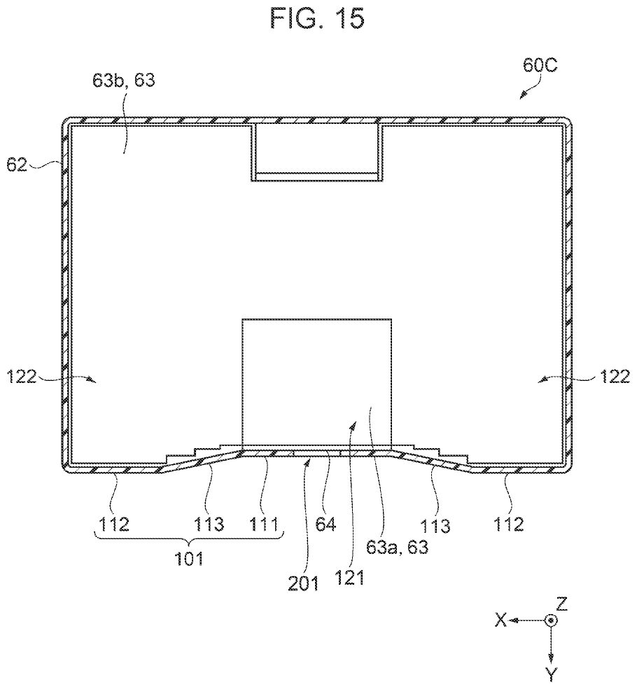

As illustrated in FIG. 15, the absorber 63 is disposed inside the casing 62 at a first region 121 where the absorber 63 faces with the connection portion 64 and at a second region 122. The second region 122 is located at a position that is relatively distant from the connection portion 64 in comparison with the first region 121. The liquid retention ability of the absorber 63 at the first region 121 is less than the liquid retention ability of the absorber 63 at the second region 122. The first region 121 includes a region facing with the first portion 111. The second region 122 includes a region facing with the second portion 112 and the third portion 113. Because of this structure, the flow-ability of discharged liquid is relatively high at the first region 121, and the flow of the discharged liquid from the first region 121 to the second region 122 is facilitated.

The liquid retention ability of the absorber 63 is set based on pore density of the absorber 63. Specifically, the pore density of the absorber 63 at the first region 121 is set to be lower than the pore density of the absorber 63 at the second region 122. Because of the lower pore density at the first region 121, it is possible to facilitate the flow of discharged liquid from the first region 121 toward the second region 122 due to capillary action.

In the present embodiment, as the absorber 63, a first absorber 63a is disposed at the first region 121, and a second absorber 63b is disposed at the second region 122. The pore density of the first absorber 63a is lower than the pore density of the second absorber 63b. It is possible to easily make a difference in pore density between regions by disposing plural kinds of the absorber 63 (the first absorber 63a and the second absorber 63b) that are different in pore density from each other. Another kind of the absorber 63 may be disposed between the first absorber 63a and the second absorber 63b. In this case, the pore density of this another kind of the absorber 63 is set to be higher than the pore density of the first absorber 63a and lower than the pore density of the second absorber 63b. Even if modified in this way, it is possible to cause the discharged liquid to flow from the first region 121 toward the second region 122.

Next, how the discharged liquid container 60C works when the discharged liquid container 60C is detached from the apparatus body 12, and its operational effects, will now be explained. As illustrated in FIG. 8, to detach the discharged liquid container 60C from the apparatus body 12, the user draws, in the −Y direction, the discharged liquid container 60C attached to the apparatus body 12, while gripping the grip portion 61 with the user's fingers. The discharged liquid container 60C drawn by the user moves in the −Y direction, the outlet portion 55 becomes disconnected from the connection portion 64, and the discharged liquid container 60C is detached from the apparatus body 12.

When the user carries the discharged liquid container 60C while gripping the grip portion 61, the discharged liquid container 60C might be in first orientation in which the grip portion 61 of the discharged liquid container 60C is oriented upward and in which the connection portion 64 is oriented downward. If the discharged liquid container 60C that is being carried is in such a first orientation, there is a risk that the dripping of the discharged liquid contained in the casing 62 from the connection portion 64 in the direction of gravity might occur, unless prevented. The first orientation is not limited to the orientation in which the direction of the connection portion 64 is the direction of gravity. The first orientation may be any orientation including a downward component.

However, in the present embodiment, when the discharged liquid container 60C is in the first orientation, since the second portion 112 is located at a lower position in comparison with the first portion 111, at which the connection portion 64 is provided, the discharged liquid contained in the casing 62 moves from the first portion 111 toward the second portion 112. This structure makes it possible to prevent the discharged liquid from dripping from the connection portion 64.

Moreover, since the first portion 111 and the second portion 112 are connected to each other via the third portion 113 that is a slope, it is possible to cause the discharged liquid to move smoothly from the first portion 111 toward the second portion 112, that is, from the first region 121 toward the second region 122.

Furthermore, since the absorber 63 (the first absorber 63a and the second absorber 63b) is disposed inside the casing 62, it is possible to cause the discharged liquid to move smoothly from the first region 121 toward the second region 122 and to absorb and retain the discharged liquid having been drained into the casing 62 via the connection portion 64. The absorption and retention by the absorber 63 makes it possible to prevent the discharged liquid from dripping from the connection portion 64.

Still furthermore, since the second portion 112 of the discharged liquid container 60C is rounded, it is difficult to place the discharged liquid container 60C with the first face 101 facing downward. Since the discharged liquid container 60C cannot be placed with the connection portion 64 oriented downward, the connection portion 64 will never be in downward orientation in a placed state; therefore, it is possible to prevent discharged liquid from dripping from the connection portion 64.

### 5. Fifth Embodiment

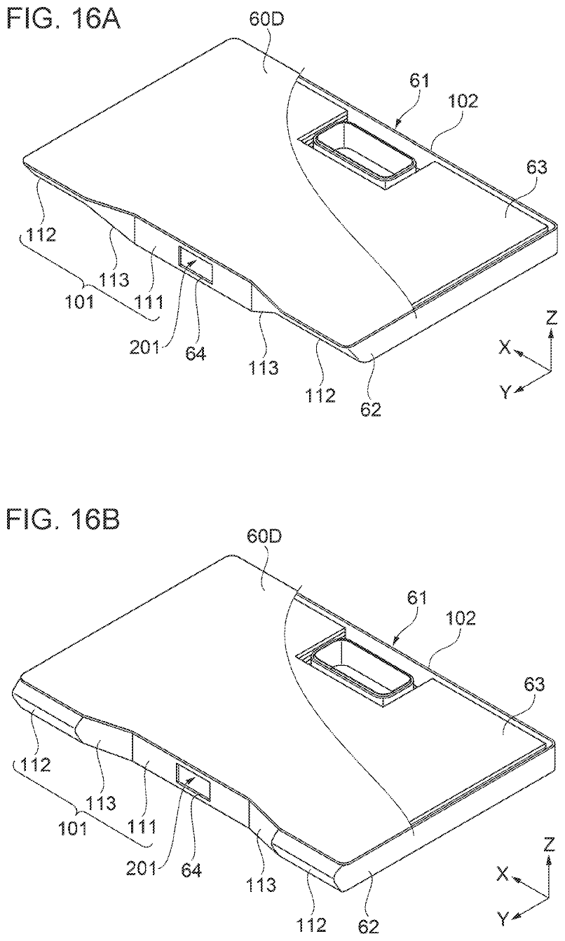

Next, a fifth embodiment will now be explained. The same reference numerals are assigned to components that are the same as those of the first embodiment. An explanation of them is omitted. In the discharged liquid container 60C according to the fourth embodiment, the second portion 112 has a rounded shape. However, the shape of the second portion 112 is not limited to a rounded shape. The second portion 112 of a discharged liquid container 60D according to the present embodiment has a sloped surface that makes it difficult for the discharged liquid container 60D to be placed in an upright position on a desk, a floor, or the like. Specifically, as illustrated in FIG. 16A, the discharged liquid container 60D has a sloped surface that is sloped from the −Z-directional-side end to +Z-directional-side end of the second portion 112 when viewed in the +X direction. Because of this structure, the discharged liquid container 60D cannot be placed with the first face 101 facing downward. Since the discharged liquid container 60D cannot be placed with the connection portion 64 oriented downward, the connection portion 64 will never be in downward orientation in a placed state; therefore, it is possible to prevent discharged liquid from dripping from the connection portion 64. Alternatively, as illustrated in FIG. 16B, the second portion 112 may have two sloped surfaces, one sloping from the −Z-directional-side end of the second portion 112 and the other sloping from the +Z-directional-side end of the second portion 112, in such a way as to form a convex structure protruding in the +Y direction. Even if modified in this way, it is possible to obtain the same effects as those described above.

### 6. Sixth Embodiment

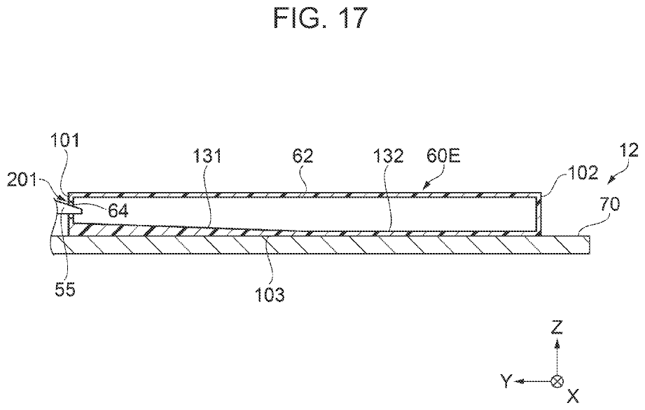

Next, a sixth embodiment will now be explained. The same reference numerals are assigned to components that are the same as those of the first embodiment. An explanation of them is omitted. In the foregoing embodiment, the projection 130 is provided on the third face 103. However, the scope of the present disclosure is not limited thereto. In a discharged liquid container 60E according to the present embodiment, as illustrated in FIG. 17, a sloped surface 131 that is sloped down in the −Y direction from the +Y-directional-side end is provided inside the casing 62. Therefore, the inside of the third face 103 is a downward slope, and this structure prevents the discharged liquid from flowing toward the connection portion 64. In the discharged liquid container 60E according to the present embodiment, the inner surface is made up of the sloped surface 131, which is sloped down in the −Y direction from the +Y-directional-side end, and a horizontal surface 132, which is provided on the −Y-directional side with respect to the −Y-directional-side end of the sloped surface 131. However, for example, the horizontal surface 132 may be omitted, and the sloped surface 131 may be formed throughout the entire inner region continuously to −Y-directional-side end of the inside of the casing 62. A recess that is sloped down toward the center from the first face 101 and from the second face 102 may be formed.

In the first to sixth embodiments, an agent that has an affinity for the liquid may be applied to the neighborhood of the connection portion 64 (opening) of the first face 101 of the casing 62 and to the outer surface and the neighborhood of the lid portion 201, 211, 221. Treatment for affinity for the liquid may be applied. If such an agent or treatment for affinity for the liquid is applied, discharged liquid leaking out through the connection portion 64 spreads. Therefore, it is possible to prevent the discharged liquid from dripping in the form of droplets easily.

The shape/structure, etc. of the grip portion 61 in the first to sixth embodiments is not limited. For example, the grip portion 61 may be a through hole, a concave or convex portion, a protruding portion, a recessed portion, or the like. It is sufficient as long as a part of the second face 102 is configured to be able to be gripped.

The discharged liquid container 60 according to the foregoing embodiments has been described as a container configured to contain, as discharged liquid, waste liquid that is generated when borderless printing or maintenance, etc. is performed. For example, the discharged liquid container 60 may be a container that is able to contain usable liquid (for example, ink). For example, the discharged liquid container 60 may be an ink cartridge, etc.

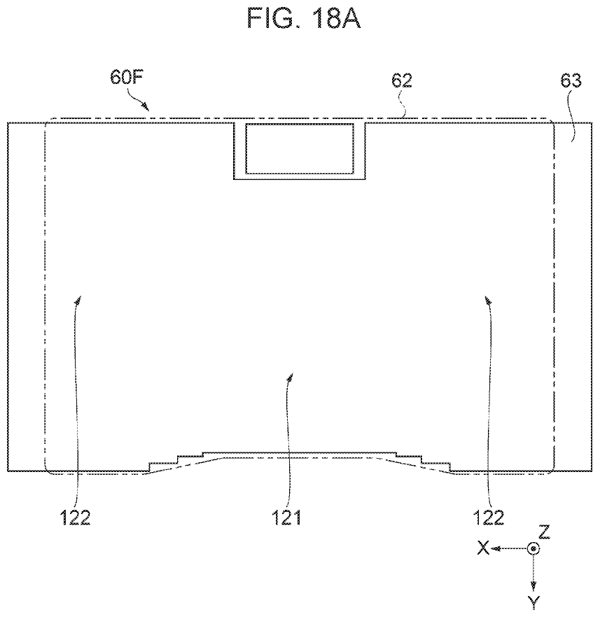

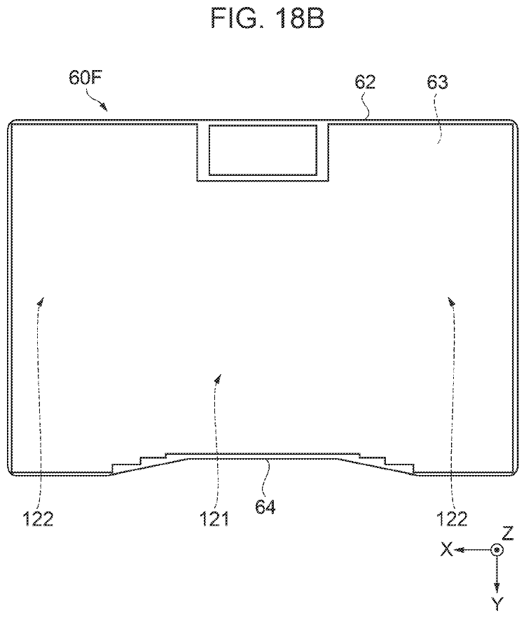

The absorber 63 is not limited to an absorber that includes the first absorber 63a and the second absorber 63b and forms a difference in pore density by the first absorber 63a and the second absorber 63b. For example, the absorber 63 of the discharged liquid container 60C illustrated in FIG. 14B may be formed such that the size, in a first direction, of its portion that is to be disposed at the second region 122 when put into the casing 62 will be larger than the internal dimension of the casing 62 in the first direction. The first direction may be the direction along the X axis, or the direction along the Y axis, or the direction along the Z axis. In the example of a discharged liquid container 60F illustrated in FIG. 18A, the portion, of the absorber 63, that is to be disposed at the second region 122 has a size in the direction along the X axis that is larger than the internal size of the casing 62 in the direction along the X axis. The pore density of the absorber 63 is uniform. As illustrated in FIG. 18B, the absorber 63 is put into the casing 62. Since the portion corresponding to the second region 122 is larger than the internal dimension of the casing 62, when the absorber 63 is put into the casing 62, the portion, of the absorber 63, corresponding to the second region 122 is compressed into the casing 62. Therefore, it is possible to make the pore density at the second region 122 higher than the pore density at the first region 121. Since the discharged liquid container 60F can be manufactured using only one absorber 63 having the same pore density, its manufacturing is easier.

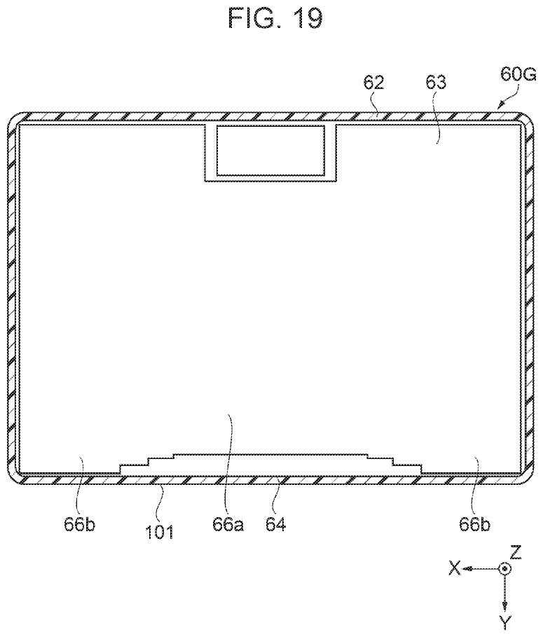

In another example, as illustrated in FIG. 19, a discharged liquid container 60G includes the casing 62 whose first face 101 extends along the X axis, and further includes the absorber 63 provided inside the casing 62. The absorber 63 includes a first absorber portion 66a, which faces with the connection portion 64, and a second absorber portion 66b, which is located on a nearer side in comparison with the first absorber portion 66a in a plan view from the side where the first face 101 is located. Even if modified in this way, it is possible to prevent discharged liquid from dripping from the connection portion 64 because the discharged liquid flows from the first absorber portion 66a to the second absorber portion 66b when the connection portion 64 is oriented downward.

A discharged liquid container includes a casing inside which discharged liquid is containable, a connection portion provided in a first face of the casing and configured to be coupled to an outlet portion, and an absorber configured to absorb the discharged liquid. The first face includes a first portion, in which the connection portion is provided, and a second portion protruding in comparison with the first portion in a direction intersecting with the first face. Because of this structure, even if the discharged liquid container is gripped with the connection portion oriented downward, discharged liquid contained in the casing flows toward the second portion, which is located at a lower position in comparison with the connection portion; therefore, it is possible to prevent the discharged liquid from dripping from the connection portion.

The first face may further include a third portion that is sloped for connection between the first portion and the second portion. With this structure, it is possible to cause the discharged liquid to flow smoothly from the first portion toward the second portion.

The second portion may be a sloped surface. This structure prevents the discharged liquid container from being placed with the first face facing downward. Since the discharged liquid container cannot be placed with the connection portion oriented downward, the connection portion will never be in downward orientation in a placed state; therefore, it is possible to prevent discharged liquid from dripping from the connection portion.

Alternatively, the second portion may have a rounded shape. This structure also prevents the discharged liquid container from being placed with the first face facing downward. Since the discharged liquid container cannot be placed with the connection portion oriented downward, the connection portion will never be in downward orientation in a placed state; therefore, it is possible to prevent discharged liquid from dripping from the connection portion.

The casing may have a third face intersecting with the first face, and, when the discharged liquid container is placed with the third face facing down, the inside of the third face may be sloped down toward a direction going away from the position of junction of the first face and the third face. With this structure, since the inside of the third face is a downward slope, it is possible to prevent the discharged liquid from flowing toward the connection portion.

A projection may be provided on the third face at a position closer to the first face than the center is. Since the discharged liquid container is placed with a slope going down in the −Y direction due to the presence of the projection, it is possible to prevent discharged liquid from flowing toward the connection portion. The discharged liquid container may be placed on a desk or a floor, with the projection of the discharged liquid container oriented downward. Even if the discharged liquid container is placed in this way, the casing is sloped down from the first face toward the second face and, therefore, it is possible to prevent discharged liquid from flowing toward the connection portion.

The liquid retention ability of a first region of the absorber facing with the connection portion may be less than the liquid retention ability of a second region of the absorber that is relatively distant from the connection portion in comparison with the first region is. For example, the first region includes a region facing with the first portion. The second region includes a region facing with the second portion and the third portion. Because of this structure, the flow-ability of discharged liquid is relatively high at the first region, and the flow of the discharged liquid from the first region to the second region is facilitated.

The pore density of the absorber at the first region may be lower than the pore density of the absorber at the second region. The liquid retention ability of the absorber is set based on pore density of the absorber. Because of the lower pore density at the first region, it is possible to facilitate the flow of discharged liquid from the first region toward the second region due to capillary action.

The absorber may include a first absorber disposed at the first region and a second absorber disposed at the second region, and the pore density of the first absorber may be lower than the pore density of the second absorber. It is possible to easily make a difference in pore density between regions by disposing plural kinds of the absorber (the first absorber and the second absorber) that are different in pore density from each other. Another kind of the absorber may be disposed between the first absorber and the second absorber. In this case, the pore density of this another kind of the absorber is set to be higher than the pore density of the first absorber and lower than the pore density of the second absorber. With the difference in pore density, it is possible to cause the discharged liquid to flow from the first region toward the second region.

Alternatively, the absorber may be formed such that the size, in a first direction, of its portion that is to be disposed at the second region when put into the casing will be larger than the internal dimension of the casing in the first direction. Since the portion corresponding to the second region is larger than the internal dimension of the casing, when the absorber is put into the casing, the portion, of the absorber, corresponding to the second region is compressed into the casing. Therefore, it is possible to make the pore density at the second region higher than the pore density at the first region. Since the discharged liquid container can be manufactured using only one absorber having the same pore density, its manufacturing is easier.

What is claimed is:

1. A discharged liquid container detachable to an apparatus and configured to contain discharged liquid, the apparatus having an outlet portion from which the discharged liquid is to be drained, the discharged liquid container being configured to contain the discharged liquid drained from the outlet portion, the discharged liquid container comprising:
a casing inside which the discharged liquid is containable;
a connection portion provided in a first face of the casing and configured to be coupled to the outlet portion; and
a lid portion configured to change in position between a closed state for covering the connection portion and an open state for opening the connection portion; wherein
the lid portion is configured to be in the open state in a state of attachment of the casing to the apparatus and be in the closed state in a state of detachment of the casing from the apparatus.

2. The discharged liquid container according to claim 1, wherein the lid portion is in the closed state when the casing is detached from the apparatus and the first face is facing downward.

3. The discharged liquid container according to claim 1, wherein the lid portion is in the closed state at a point in time of detachment of the casing from the apparatus.

4. The discharged liquid container according to claim 3, wherein the lid portion is urged toward the closed state, and changes in position from the open state into the closed state by an urging force.

5. The discharged liquid container according to claim 4, wherein, in a process of coupling of the outlet portion to the connection portion, the outlet portion causes the lid portion to change in position from the closed state into the open state against the urging force.

6. The discharged liquid container according to claim 1, wherein the lid portion changes in position from the open state into the closed state due to own weight of the lid portion.

7. The discharged liquid container according to claim 6, wherein, in a process of coupling of the outlet portion to the connection portion, the outlet portion causes the lid portion to change in position from the closed state into the open state against the own weight.

8. The discharged liquid container according to claim 1, wherein the lid portion is provided rotatably on the connection portion.

9. The discharged liquid container according to claim 1, wherein
the lid portion is an elastic member configured to cover the connection portion, and
the elastic member has a slit.

10. The discharged liquid container according to claim 1, further comprising:
a grip portion provided on a second face of the casing, the second face being an opposite of the first face.

11. The discharged liquid container according to claim 1, wherein the first face is an upper surface of the casing when the casing is attached to the apparatus.

12. The discharged liquid container according to claim 1, wherein the first face includes a first portion and a second portion, the first portion is a portion in which the connection portion is provided, and the second portion is bulged from the first portion.

13. The discharged liquid container according to claim 12, wherein the first face further includes a third portion that is sloped for connection between the first portion and the second portion.

14. The discharged liquid container according to claim 12, wherein the second portion is a sloped surface.

15. The discharged liquid container according to claim 1, wherein
the casing has a third face intersecting with the first face, and
when the discharged liquid container is placed with the third face facing down, an inside of the third face is sloped down toward a direction going away from a position of junction of the first face and the third face.

16. The discharged liquid container according to claim 15, wherein a projection is provided on the third face at a position closer to the first face than a center is.

17. The discharged liquid container according to claim 1, further comprising:
an absorber provided inside the casing and configured to absorb the discharged liquid.

18. The discharged liquid container according to claim 17, wherein
liquid retention ability of a first region of the absorber facing with the connection portion is less than liquid retention ability of a second region of the absorber that is distant from the connection portion in comparison with the first region is.

19. A recording apparatus to which the discharged liquid container according to claim 1 is detachable, the recording apparatus comprising:
a recording unit that performs recording by ejecting liquid onto a medium; wherein
the discharged liquid container is configured to contain, as the discharged liquid, the liquid ejected onto a region outside an edge of the medium from the recording unit.

20. A recording apparatus to which the discharged liquid container according to claim 1 is detachable, the recording apparatus comprising:
a recording unit that performs recording by ejecting liquid onto a medium; wherein
the discharged liquid container is configured to contain the discharged liquid generated by performing maintenance.
